(19) United States
(12) Patent Application Publication
(10) Pub. No.: US 2023/0023740 A1
(43) Pub. Date: Jan. 26, 2023

(54) INFORMATION PROCESSING DEVICE, INFORMATION PROCESSING METHOD, AND RECORDING MEDIUM

(71) Applicant: SHARP KABUSHIKI KAISHA, Sakai City (JP)

(72) Inventor: KOHJI KUMETANI, Sakai City (JP)

(21) Appl. No.: 17/957,309

(22) Filed: Sep. 30, 2022

Related U.S. Application Data
(63) Continuation of application No. 16/876,746, filed on May 18, 2020.

(30) Foreign Application Priority Data
May 29, 2019 (JP) 2019-100123

(51) Int. Cl. G06F 40/117; G06F 3/0484; G06F 3/0354

(52) U.S. Cl. CPC G06F 40/117; G06F 3/0484; G06F 3/03545

(57) ABSTRACT

Provided is an information processing device including an input detector that detects a designated position of a display, a tag generator that generates a tag image by associating the position detected by the input detector with input information to be input and displays the generated tag image on the display, and a display processor that displays, on the display, a plurality of pieces of the input information associated with each of a plurality of the tag images generated by the tag generator, based on each of attributes of the plurality of tag images.

### INCORPORATION BY REFERENCE

This application is a continuation of U.S. Pat. Application No. 16/876746, filed May 18, 2020, which claims the benefit of priority from the corresponding Japanese Patent Application No. 2019-100123 filed on May 29, 2019, the entire contents of which are incorporated herein by reference.

### BACKGROUND OF THE INVENTION

### Field of the Invention

The present disclosure relates to an information processing device in which it is possible to draw (input) drawing information on a display with a touch pen, and also relates to an information processing method and an information processing program.

### Description of the Background Art

Conventionally, an electronic board (also referred to as an electronic blackboard or an electronic whiteboard) is known as one of display devices (information processing devices) in which a touch panel is used to receive an instruction input (touch) from a user. The electronic board reads position coordinates of information (an object) handwritten with a touch pen or the like on a touch panel, recognizes the object as a character, based on the information of the read position coordinates, converts the character into text, and displays the converted text on a display.

There is proposed a tag image in which a so-called tag paper is electronically represented on the electronic board. A tag function enables display of various opinions in tag images at a meeting or the like. However, a conventional tag function only has a mode for displaying a plurality of tag images on a display, a mode for moving the tag images to any position, and the like, and it is difficult to efficiently create materials such as meeting minutes.

### SUMMARY OF THE INVENTION

An object of the present disclosure is to provide an information processing device capable of efficiently creating materials utilizing a tag function, and also to provide an information processing method and an information processing program.

An information processing device according to an aspect of the present disclosure includes an input detector that detects a designated position of a display, a tag generator that generates a tag image by associating the position detected by the input detector with input information to be input and displays the generated tag image on the display, and a display processor that displays, on the display, a plurality of pieces of the input information associated with each of a plurality of the tag images generated by the tag generator, based on each of attributes of the plurality of tag images.

An information processing method according to another aspect of the present disclosure includes using one or more processors to execute: an input detection process for detecting a designated position of a display; a tag generation process for generating a tag image by associating the position detected in the input detection process with input information to be input, and displaying the generated tag image on the display; and a display process for displaying, on the display, a plurality of pieces of the input information associated with each of a plurality of the tag images generated in the tag generation process, based on each of attributes of the plurality of tag images.

In a non-transitory recording medium for storing an information processing program according to another mode of the present disclosure, the program causes one or more processors to execute: an input detection process for detecting a designated position of a display, a tag generation process for generating a tag image by associating the position detected in the input detection process with input information to be input, and displaying the generated tag image on the display, and a display process for displaying, on the display, a plurality of pieces of the input information associated with each of a plurality of the tag images generated in the tag generation process, based on each of attributes of the plurality of tag images.

According to the present disclosure, it is possible to provide an information processing device capable of efficiently creating materials utilizing a tag function, and also to provide an information processing method, and an information processing program.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a configuration of an information processing device according to an embodiment of the present disclosure;

FIG. 2 is a diagram illustrating an example of tag information utilized in the information processing device according to the embodiment of the present disclosure;

FIG. 3A is a diagram illustrating an example of a display screen displayed on a display according to the embodiment of the present disclosure;

FIG. 3B is a diagram illustrating an example of a display screen displayed on the display according to the embodiment of the present disclosure;

FIG. 3C is a diagram illustrating an example of a display screen displayed on the display according to the embodiment of the present disclosure;

FIG. 4 is a diagram illustrating an example of a display screen displayed on the display according to the embodiment of the present disclosure;

FIG. 5 is a diagram illustrating an example of a first sheet displayed on the display according to the embodiment of the present disclosure;

FIG. 6 is a diagram illustrating an example of a second sheet displayed on the display according to the embodiment of the present disclosure;

FIG. 7 is a diagram illustrating an example of a third sheet displayed on the display according to the embodiment of the present disclosure;

FIG. 8 is a diagram illustrating another example of the first sheet displayed on the display according to the embodiment of the present disclosure;

FIG. 9 is a diagram illustrating another example of the second sheet displayed on the display according to the embodiment of the present disclosure;

FIG. 10 is a diagram illustrating another example of the third sheet displayed on the display according to the embodiment of the present disclosure;

FIG. 11 is a flowchart for explaining an example of a procedure of information processing in the information processing device according to the embodiment of the present disclosure;

FIG. 12 is a flowchart for explaining an example of a procedure of a tag generation process in the information processing device according to the embodiment of the present disclosure;

FIG. 13 is a flowchart for explaining an example of a procedure of a tag change process in the information processing device according to the embodiment of the present disclosure; and

FIG. 14 is a flowchart for explaining an example of a procedure of a material creation process in the information processing device according to the embodiment of the present disclosure.

### DESCRIPTION OF THE PREFERRED EMBODIMENTS

An embodiment of the present disclosure will be described below with reference to the attached drawings. The following embodiment is an example in which the present disclosure is embodied, and does not intend to limit the technical scope of the present disclosure.

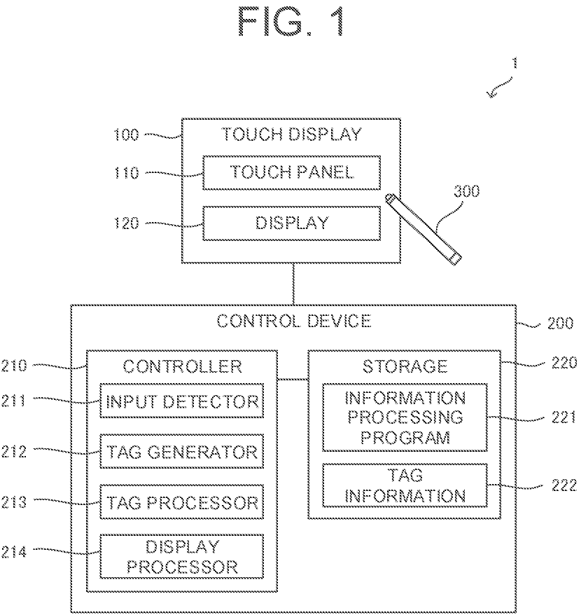

As illustrated in FIG. 1, an information processing device 1 according to the embodiment of the present disclosure includes a touch display 100, a control device 200, and a touch pen 300. The control device 200 is a computer that is connected to the touch display 100 and that controls the touch display 100. The touch pen 300 is connected to the control device 200 via a network (wireless communication or wired communication). The touch pen 300 may be omitted.

The touch display 100 includes a touch panel 110 and a display 120. The touch panel 110 may be a capacitive touch panel, or may be a pressure sensitive or an infrared ray touch panel. That is, the touch panel 110 may be any device capable of appropriately receiving a user operation input such as a touch. The touch panel 110 is provided in the display 120. The display 120 is, for example, a liquid crystal display. The display 120 is not limited to a liquid crystal display, and may be a light emitting diode (LED) display, an organic electro-luminescence (EL) display, a projector, or the like.

The touch display 100 may be a device such as a computer, a tablet terminal, a smartphone, and a car navigation system where a touch panel is provided.

The touch pen 300 is a pen used by a user to touch (input into) the touch display 100. If the touch pen 300 is omitted, the user touches (inputs to) the touch display 100 with a finger. For example, the user inputs (draws) an obj ect such as a character or a figure by handwriting with the touch pen 300 or a finger.

As illustrated in FIG. 1, the control device 200 includes a storage 220 and a controller 210.

The storage 220 is a non-volatile storage such as a hard disk drive (HDD) or a solid state drive (SSD) that stores various types of information.

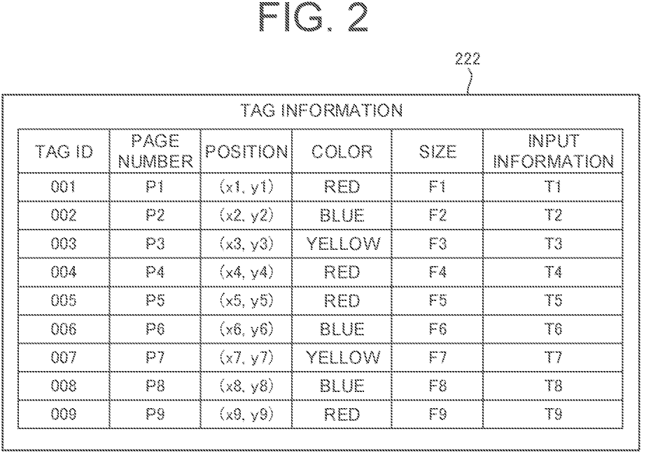

Specifically, the storage 220 stores tag information 222 on a tag image created on the touch display 100 by the user. FIG. 2 is a diagram illustrating an example of the tag information 222. As illustrated in FIG. 2, information such as “tag ID”, “page number”, “position”, “color”, “size”, and “input information” for each tag image P is registered with the tag information 222. The “tag ID” is identification information of the tag image P. The “page number” is the number of the page on which the tag image P is generated. The “position” is a coordinate position of the tag image P on the display 120. The “color” is a background color of the tag image P. The “color” is an example of an attribute of a tag image according to the present disclosure. The “size” is the size of an outer shape of the tag image P on the display 120. The “input information” is information input by the user, such as a character, a figure, and a symbol displayed in an area of the tag image P. The user may input the input information with the touch pen 300 or a finger on the touch panel 110, or may input the input information using an operation device such as a keyboard and a mouse. In the tag information 222, the above information is stored in an order (time series) in which the tag images P are generated.

Further, the storage 220 also stores input information input to an area other than the tag image P.

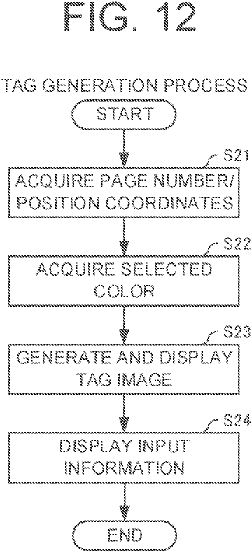

Further, the storage 220 stores a control program such as an information processing program 221 for causing the controller 210 to execute information processing (see FIG. 11) described later. For example, the information processing program 221 is recorded non-temporarily on a computer-readable recording medium such as a CD or a DVD, read by a reading device (not illustrated) such as a CD drive or a DVD drive provided in the information processing device 1, and stored in the storage 220.

The controller 210 includes a control device such as a CPU, a ROM, and a RAM. The CPU is a processor that executes various types of arithmetic processes. The ROM is a non-volatile storage in which a control program such as BIOS and OS for causing the CPU to execute various types of arithmetic processes is stored in advance. The RAM is a volatile or non-volatile storage that stores various types of information, and is used as a temporary storage memory (working area) for various types of processes executed by the CPU. The controller 210 controls the information processing device 1 by causing the CPU to execute various types of control programs stored in advance in the ROM or the storage 220.

Specifically, as illustrated in FIG. 1, the controller 210 includes various types of processing devices such as an input detector 211, a tag generator 212, a tag processor 213, and a display processor 214. The controller 210 functions as the various types of processing devices by causing the CPU to execute various types of processes according to the information processing program 221. Further, some or all of the processing devices may be configured by an electronic circuit. The information processing program 221 may be a program for causing a plurality of processors to function as the various types of processing devices.

The input detector 211 detects an input to the touch display 100 by the touch pen 300 or a finger. The input detector 211 is an example of an input detector according to the present disclosure. Specifically, the input detector 211 detects the page number and position coordinates of a position specified by the touch pen 300 or the finger of the user on the touch panel 110. For example, if the user inputs a character by handwriting on the touch panel 110, the input detector 211 detects the page number and the position coordinates of the input position. Further, if the user performs an operation to activate a tag function on the touch panel 110, the input detector 211 detects the page number and the position coordinates of a position corresponding to the operation. Specifically, if the user maintains the contact state of the touch pen 300 at any position of the touch panel 110 (depresses the touch panel 110 with the touch pen 300 at any position) for a predetermined time, the tag function is activated (the mode transitions to a tag mode). In this case, the input detector 211 detects the contact position of the touch pen 300, that is, the page number and the position coordinates of the position of the touch panel 110 depressed by the touch pen 300 for a predetermined time.

The tag generator 212 generates the tag image P by associating the page number and the position detected by the input detector 211 with the input information input by the user, and displays the generated tag image P on the display 120. Further, the tag generator 212 displays the input information in the area of the tag image P selected on the display 120. The tag generator 212 is an example of a tag generator according to the present disclosure.

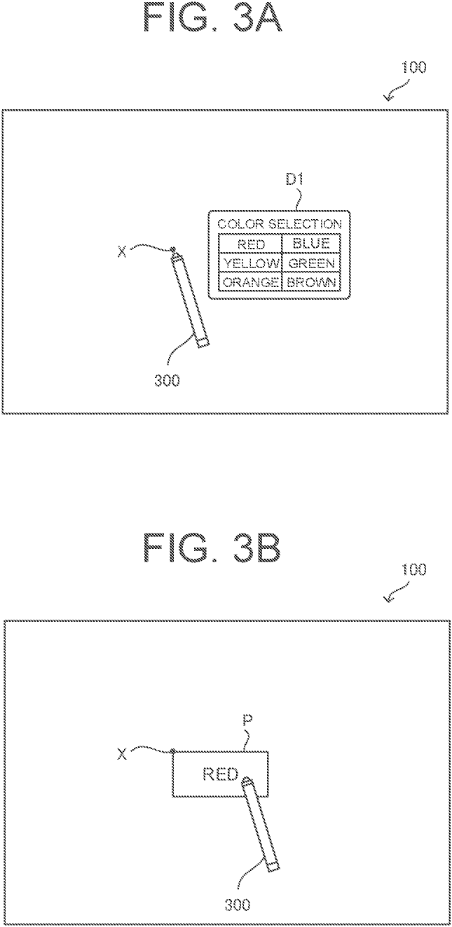

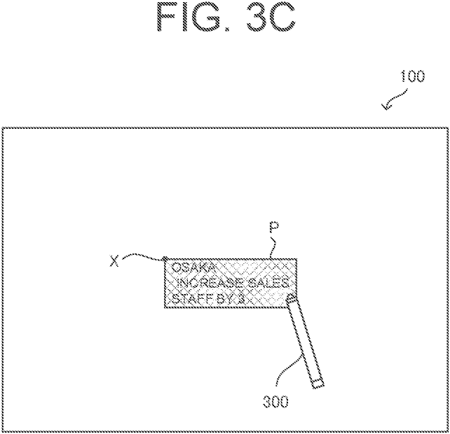

For example, as illustrated in FIG. 3A, if the user depresses the touch panel 110 at any position X with the touch pen 300 for a long time to shift to the tag mode, the tag generator 212 displays a tag selection screen D1 on the display 120. Next, if the user selects a desired color on the tag selection screen D1 with the touch pen 300, as illustrated in FIG. 3B, the tag generator 212 displays the tag image P with the background color of the selected color at the position X on the display 120. FIG. 3B illustrates the tag image P with the background color being red. Next, if the user selects the tag image P with the touch pen 300, the mode shifts to an input mode for displaying information in the area of the tag image P. If the mode shifts to the input mode, the user inputs a character, a figure, a symbol, and the like using the touch pen 300 or an operation device (such as a keyboard). For example, as illustrated in FIG. 3C, if the user inputs by handwriting the characters “Osaka, Increase sales staff by 3” in the tag image P with the touch pen 300, the tag generator 212 displays the input characters (input information) in the area of the tag image P. The tag generator 212 may display the input information in the tag image P in a handwritten font, or may display the input information in the tag image P in a previously set font (typeface, character size, character color), or may display the input information in the tag image P in a font selected by the user. The user selects a color in accordance with the category of the input information (such as the provider of the input information and the content of the input information).

Here, the tag selection screen D1 may include an item for selecting the size of the tag image P. In this case, the tag generator 212 generates the tag image P in a size selected by the user. If the item for selecting the size of the tag image P is not included in the tag selection screen D1, the tag generator 212 generates the tag image P in a size at an initial setting. The size of the tag image P may be changed (enlarged or reduced) at any timing after the tag image P is displayed on the display 120.

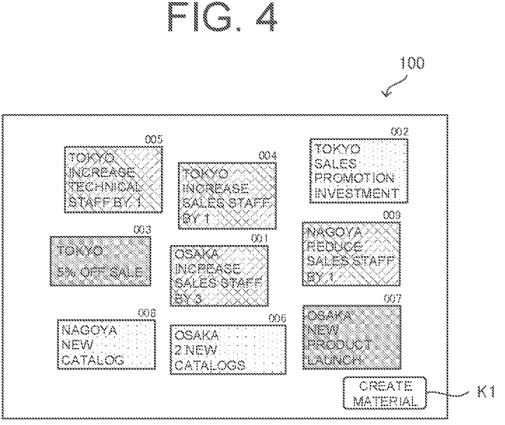

The tag generator 212 registers, with the tag information 222, tag information corresponding to the generated tag image P. Specifically, the tag generator 212 registers, with the tag information 222, information including the page number at which the tag image P is generated, the position coordinates corresponding to the position X (display position) of the tag image P, the color, the size, and the input information, in association with the identification information (tag ID) of the tag image P. For example, for the tag image P corresponding to FIG. 3C, the tag ID “001” is registered in association with the position coordinates (x1, y1) corresponding to the position X, the color “red”, the size “F1”, and the input information “T1” (“Osaka, Increase sales staff by 3”) (see FIG. 2). FIG. 4 illustrates a display screen of the display 120 in which nine tag images P are generated and displayed by the tag generator 212. The tag information 222 illustrated in FIG. 2 indicates the tag information of the nine tag images P illustrated in FIG. 4. In FIG. 4, each of the tag images P is provided with a tag ID for convenience. Further, in the example illustrated in FIG. 4, the tag images P with the tag IDs “001”, “004”, “005”, and “009” have a common attribute (“red”), the tag images P with the tag IDs “002”, “006”, and “008” have a common attribute (“blue”), and the tag images P with the tag IDs “003” and “007” have a common attribute (“yellow”).

The tag processor 213 changes at least any one of the page number, the position, the color (background color), the size, and the input information of the tag image P displayed on the display 120. The tag processor 213 is an example of a tag processor according to the present disclosure.

For example, in the display screen illustrated in FIG. 4, if the user replaces the position of the tag image P having the tag ID “003” with the position of the tag image P having the tag ID “001” using the touch pen 300, the tag processor 213 changes the position of each of the tag images P. Further, in the display screen illustrated in FIG. 4, if the user selects the tag image P by the touch pen 300 to perform an operation of changing the background color, the tag processor 213 changes the color of the tag image P. Further, in the display screen illustrated in FIG. 4, if the user performs an operation of changing the size of the tag image P with the touch pen 300, the tag processor 213 changes the size of the tag image P. Further, in the display screen illustrated in FIG. 4, if the user selects the tag image P by the touch pen 300 to shift to the input mode and rewrite the input information, the tag processor 213 changes the input information displayed on the tag image P.

If at least any one of the page number, the position, the background color, the size, and the input information of the tag image P is changed, the tag processor 213 updates the corresponding information of the tag information 222 (see FIG. 2).

The display processor 214 displays, on the display 120, a plurality of pieces of input information associated with each of the plurality of tag images P generated by the tag generator 21, based on each of attributes of the plurality of tag images P2. The display processor 214 is an example of a display processor according to the present disclosure. Specifically, the display processor 214 sorts the plurality of pieces of input information into different areas or different pages for each of the attributes based on the tag information 222, and then displays the sorted information.

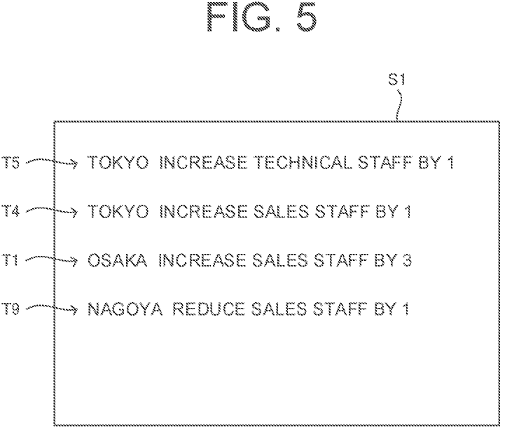

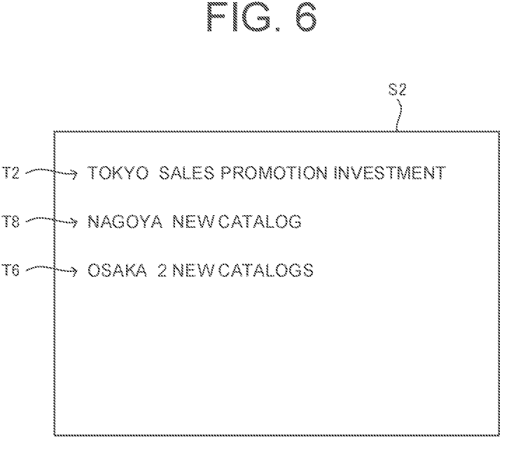

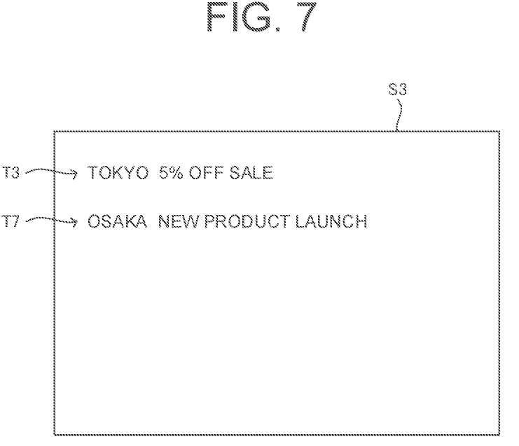

For example, the display processor 214 displays, in a first area, first input information associated with one or more first tag images P having the attribute of a first color, and displays, in a second area, second input information associated with one or more second tag images P having the attribute of a second color. For example, in the display screen illustrated in FIG. 4, if the user selects a “material creation” selection key K1, the display processor 214 displays input information associated with the tag images P with the tag IDs “001”, “004”, “005”, and “009” having the attribute “red” on a first sheet S1 (see FIG. 5), displays input information associated with the tag images P with the tag IDs “002”, “006”, and “008” having the attribute “blue” on a second sheet S2 (see FIG. 6), and displays input information associated with the tag images P with the tag IDs “003” and “007” having the attribute “yellow” on a third sheet S3 (see FIG. 7). The first sheet S1, the second sheet S2, and the third sheet S3 may be included in one page or may be included in different pages. Thus, the display processor 214 aggregates (groups) the input information for each of the attributes of the tag images P.

Further, the display processor 214 displays the input information on a sheet based on a predetermined priority order. For example, in the display screen illustrated in FIG. 4, the priority order is set higher from right to left in the horizontal direction, and the priority order is set higher from downside to upside in the vertical direction. In this case, for example, the display processor 214 displays, on the first sheet S1, input information T5 of the tag ID “005” at an uppermost part, displays input information T4 of the tag ID “004” below the input information T5, displays input information T1 of the tag ID “001” below the input information T4, and displays input information T9 of the tag ID “009” below the input information T1. The priority order is not limited to the position of the tag image P, and may be set in accordance with the input information. For example, the priority order of the tag images P may be determined in accordance with the importance of keywords included in the input information. Further, the priority order of the tag images P may be determined in accordance with the attribute (such as a job title) of the user (information provider) corresponding to the input information.

Further, the display processor 214 may convert the input information into a predetermined display mode and then display the converted input information on the display 120. For example, as illustrated in FIGS. 5 to 7, the display processor 214 converts the typeface of the input information from a handwritten font (see FIG. 4) corresponding to a user input operation into “Gothic font” and then displays the converted input information on the display 120.

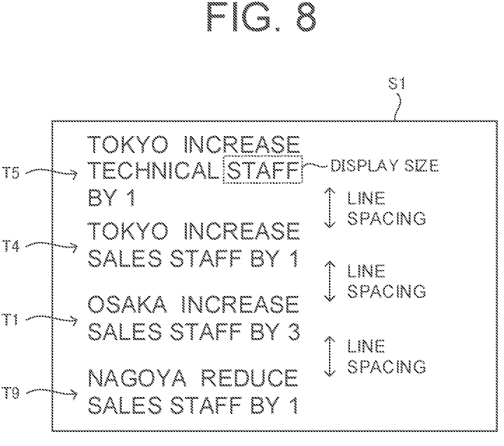

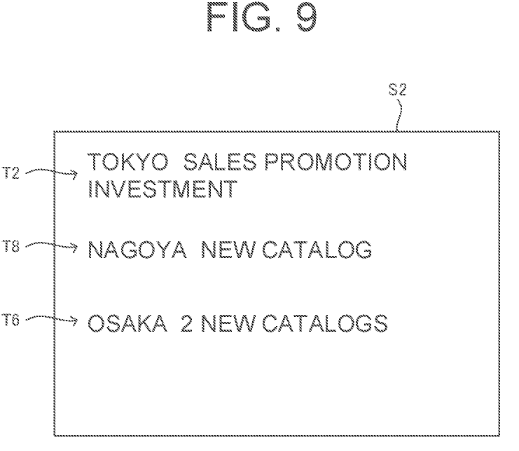

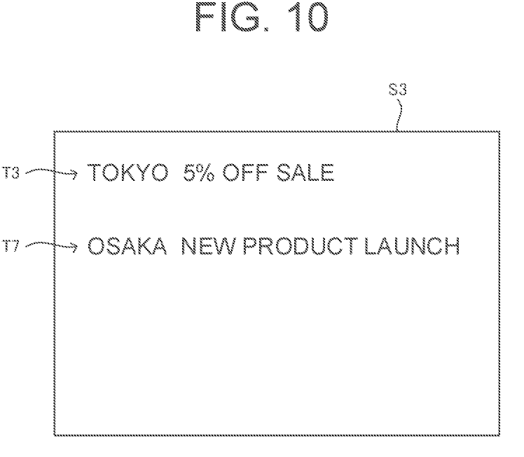

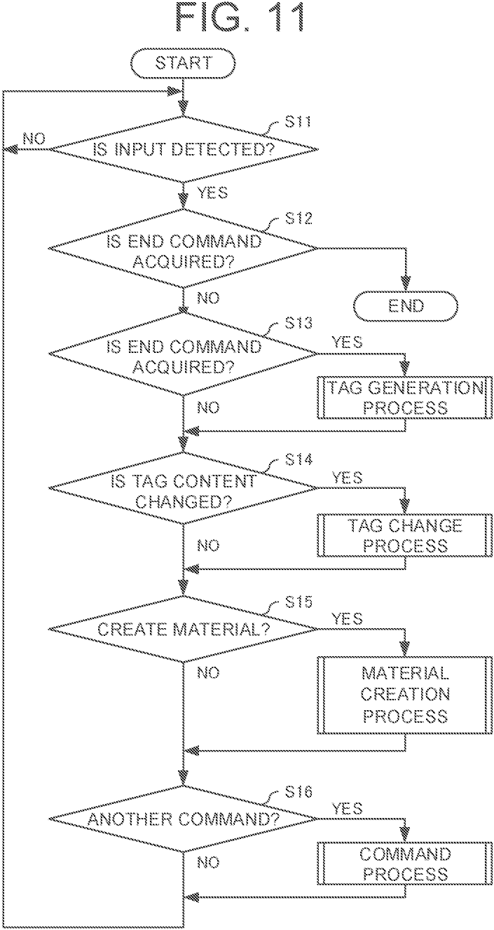

Further, the display processor 214 may determine a display size and line spacing of the characters displayed on the display 120 based on the number of characters or the number of lines of the characters included in the plurality of pieces of input information, and display the plurality of pieces of input information on the display 120 in accordance with the determined display size and line spacing. For example, if sorting the input information for each attribute, the display processor 214 determines the display size and the line spacing of the characters on the sheet (here, the first sheet S1) with the largest amount of input information (such as the number of characters and the number of lines) (see FIG. 8). The display processor 214 displays the input information on the first sheet S1 (see FIG. 8), the second sheet S2 (see FIG. 9), and the third sheet S3 (see FIG. 10) in accordance with the determined display size and line spacing.

Further, the display processor 214 may display the background color of each of the sheets in a color associated with the tag image P. For example, the display processor 214 displays the background color of the first sheet S1 in “red”, the background color of the second sheet S2 in “blue”, and the background color of the third sheet S3 in “yellow”.

In this way, the display processor 214 embeds, in each of the sheets, the input information sorted in accordance with the attributes to create a material. The display processor 214 stores (saves) the created material (sheet) in the storage 220. The controller 210 may perform control to print the material as meeting minutes or transmit data of the material to a user terminal in response to a request from the user.

The controller 210 may execute a process for drawing the input information on the display 120 in accordance with the attribute of the touch pen 300. For example, the controller 210 receives an identification signal from the touch pen 300 and performs control to draw, on the display 120, characters, figures, and symbols in accordance with the attribute (writing color, character thickness, pen tip shape, and the like) associated with the identification signal. The controller 210 may receive an identification signal of another writing instrument (such as an eraser) and perform control to execute processing (such as erasing of drawing information) in accordance with the writing instrument.

### Information Processing

Information processing executed in the information processing device 1 will be described with reference to FIG. 11 below. Specifically, in the present embodiment, the information processing is executed by the controller 210 of the information processing device 1. The controller 210 may possibly end the information processing even if the information processing is not completed, in response to a predetermined operation of the user.

The present disclosure can be regarded as an invention of an information processing method in which one or more steps included in the information processing are executed. Further, one or more steps included in the information processing described here may be omitted where appropriate. In addition, each of the steps in the information processing may be executed in a different order as long as a similar operation and effect is obtained. Further, although a case where each of the steps in the information processing is executed by the controller 210 will be described as an example here, an information processing method in which each of the steps in the information processing is executed in a distributed manner by a plurality of processors may be regarded as another embodiment.

First, in step S11, the controller 210 determines whether an input to the touch display 100 by the touch pen 300 or a finger is detected. If the input is detected (S11: YES), the processing proceeds to step S12. Step S11 is an example of an input detection process according to the present disclosure.

In step S12, the controller 210 determines whether an end command is selected by the user. If the end command is selected (S12: YES), the processing ends. If the controller 210 does not acquire the end command (S12: NO), the processing proceeds to step S13.

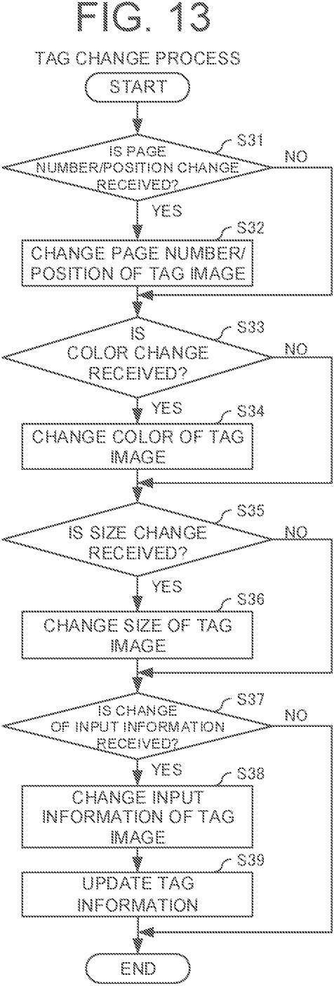

In step S13, the controller 210 determines whether the mode has shifted to the tag mode. For example, if the user maintains the contact state of the touch pen 300 at any position on the touch panel 110 (depresses the touch panel 110 with the touch pen 300 at any position on the touch panel 110) for a predetermined time, the mode shifts to the tag mode. If the mode shifts to the tag mode (S13: YES), the controller 210 executes a tag generation process described later (see FIG. 12). If the mode does not shift to the tag mode (S13: NO), the processing proceeds to step S14.

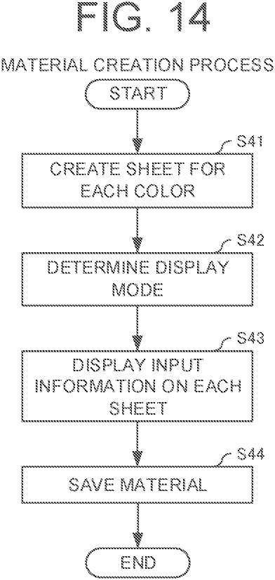

In step S14, the controller 210 determines whether a change in a tag content in the tag image P displayed on the display 120 is received from the user. If the change of the tag content is received (S14: YES), the controller 210 executes a tag change process described later (see FIG. 13). If the change of the tag content is not received from the user (S14: NO), the processing proceeds to step S15.

In step S15, the controller 210 determines whether an instruction for material creation is received from the user. If the instruction for material creation is received from the user (S15: YES), the controller 210 executes a material creation process (see FIG. 14) described later. If the instruction for material creation is not received from the user (S15: NO), the processing proceeds to step S16.

In step S16, the controller 210 determines whether another command is received from the user. If another command is received from the user (S16: YES), the controller 210 executes the command process. If another command is not received from the user (S16: NO), the processing returns to step S11. The command is, for example, a printing process and a saving process of the created material. These command processes are well-known processes and description thereof will be omitted.

### Tag Generation Process

The tag generation process will be described with reference to FIG. 12.

In step S21, the controller 210 acquires the page number and the position coordinates of an input position input by the user. Specifically, the controller 210 acquires the page number and the position coordinates of the position X on the touch panel 110 that the user depresses for a long time by the touch pen 300 (see FIG. 3A).

Next, in step S22, the controller 210 acquires the color selected by the user on the tag selection screen D1 (see FIG. 3A).

Next, in step S23, the controller 210 generates the tag image P based on the acquired position coordinates and color and performs control to display the tag image P on the display 120 (see FIG. 3B). Step S23 is an example of a tag generation step according to the present disclosure.

Next, in step S24, the controller 210 performs control to display input information input by the user in an area of the tag image P (see FIG. 3C). Then, the processing proceeds to step S14 of FIG. 11. Step S24 is an example of a display process according to the present disclosure.

### Tag Change Process

The tag change process will be described with reference to FIG. 13.

In step S31, the controller 210 determines whether an operation of changing the page number or the position of the tag image P is received from the user. If the operation is received (S31: YES), the processing proceeds to step S32. On the other hand, if the operation is not received (S31: NO), the processing proceeds to step S33.

In step S32, the controller 210 changes the page number or the position of the tag image P in response to the operation of the user. For example, if the user performs a drag-and-drop operation on the tag image P with the touch pen 300 or a finger, the page number or the position of the tag image P is moved.

In step S33, the controller 210 determines whether an operation of changing the color of the tag image P is received from the user. If the operation is received (S33: YES), the processing proceeds to step S34. On the other hand, if the operation is not received (S33: NO), the processing proceeds to step S35.

In step S34, the controller 210 changes the background color of the tag image P to a color selected by the user.

In step S35, the controller 210 determines whether an operation of changing the size of the tag image P is received from the user. If the operation is received (S35: YES), the processing proceeds to step S36. On the other hand, if the operation is not received (S35: NO), the processing proceeds to step S37.

In step S36, the controller 210 changes the size of the tag image P in response to the operation of the user. For example, if the user performs an enlargement/reduction operation such as a pinch-in/pinch-out operation on the tag image P, the controller 210 changes the size of the tag image P.

In step S37, the controller 210 determines whether an operation of changing the input information displayed on the tag image P is received from the user. If the operation is received (S37: YES), the processing proceeds to step S38. On the other hand, if the operation is not received (S37: NO), the processing ends.

In step S38, the controller 210 changes the input information displayed on the tag image P to information rewritten by the user.

In step S39, the controller 210 updates each piece of information registered in the tag information 222 (see FIG. 2) based on the information corresponding to each of the operations. Then, the processing proceeds to step S15 of FIG. 11.

### Material Creation Process

The material creation process will be described with reference to FIG. 14.

In step S41, the controller 210 creates a different area or a different sheet (page) for the input information for each attribute. For example, the controller 210 creates the first sheet S1 in red, the second sheet S2 in blue, and the third sheet S3 in yellow.

In step S42, the controller 210 determines the display mode of the input information associated with the tag image P. For example, the controller 210 converts the typeface from the handwritten font (see FIG. 4) into “Gothic font” in response to a user input operation. Further, for example, the controller 210 determines the display size and the line spacing of the characters displayed on each of the sheets, based on the number of characters or the number of lines of the characters included in the plurality of pieces of input information (see FIG. 8).

In step S43, the controller 210 performs control to display (embed) the input information on each of the sheets. For example, the controller 210 performs control to display, on the first sheet S1, the input information T1, T4, T5, and T9 associated with the red tag image P (see FIG. 5), display, on the second sheet S2, the input information T2, T6, and T8 associated with the blue tag image P (see FIG. 6), and display, on the third sheet S3, the input information T3 and T7 associated with the yellow tag image P (see FIG. 7).

In step S44, the controller 210 performs control to save the created material. For example, the controller 210 performs control to save the data of the material including the first sheet S1, the second sheet S2, and the third sheet S3 in the storage 220. Then, the processing proceeds to step S16 in FIG. 11.

The information processing device 1 according to the embodiment executes the information processing as described above.

As described above, the information processing device 1 creates an area or a page (sheet) for each attribute (color) of the tag image P, and inserts the input information of the tag image P into each page. Further, the information processing device 1 converts the handwritten characters into predetermined font characters and displays the converted characters on each page. Further, the information processing device 1 displays the characters in which the line spacing and the character size are unified in each page. As described above, the information processing device 1 can aggregate the plurality of pieces of input information in accordance with the attribute of the tag image P, and thus, efficiently create materials utilizing the tag function.

The present disclosure is not limited to the above-described embodiment. As another embodiment, the information processing device 1 may use a specific keyword displayed on the tag image P as an attribute. For example, the information processing device 1 may create a page for each specific mark (figure) displayed on the tag image P to sort the input information. Further, the keyword may be the content of the input information. For example, the information processing device 1 may create a page for each specific term included in the input information to sort the input information. As described above, the attribute according to the present disclosure may be a color, a character, a figure, or a symbol associated with the tag image P.

In a configuration of the information processing device according to the present disclosure, the touch panel 110 and the touch pen 300 may be omitted. For example, the information processing device according to the present disclosure may include the control device 200 and the display 120. Furthermore, the information processing device according to the present disclosure may include only the control device 200. In this configuration, the information processing device according to the present disclosure causes the display 120 connected via a network to execute various types of display processes.

Further, in the information processing device according to the present disclosure, the tag image may be a graphic image drawn by an operation of the user. For example, the tag image is a graphic image created by drawing application software, document creation application software, or the like, and in the graphic image, an attribute such as a color, a character, a figure, and a symbol is associated with input information input by the user. Further, in the tag image, it is possible to change at least one of a page number, a position, a background color, a size, and input information by an operation of the user. As described above, the tag image according to the present disclosure includes various electronic images that play the same role as the tag paper.

It is noted that, in the information processing device 1 according to the present disclosure, within the scope of the invention described in claims, the embodiments described above may be freely combined, or the embodiments may be appropriately modified or some of the embodiments may be omitted.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

What is claimed is:

1. An information processing device comprising:
a processor; and
a memory storing a program that causes the processor to execute control of the information processing device, wherein
the processor
detects a position on a display, the position being designated,
generates a plurality of tag images each by associating the position with input information that is input,
determines, based on a category of the input information, a priority order for displaying the plurality of tag images, and
displays the plurality of tag images on the display based on the priority order.

2. The information processing device according to claim 1, wherein the category of the input information is at least a provider of the input information or a content of the input information.

3. The information processing device according to claim 1, wherein the processor determines the priority order in accordance with importance of keywords included in the input information, or in accordance with an attribute of an information provider corresponding to the input information.

4. The information processing device according to claim 1, wherein the processor displays the input information in an area of the tag image selected on the display.

5. The information processing device according to claim 1, wherein the processor creates a page for each specific term included in the input information to sort the input information.

6. The information processing device according to claim 1, wherein the processor generates the plurality of tag images in association with designated colors, and displays background colors of the plurality of tag images in the designated colors, and
the processor displays, on the display, a plurality of pieces of the input information based on the designated colors associated with the plurality of tag images.

7. The information processing device according to claim 1, wherein the processor changes at least any one of the position, a background color, a size, and the input information of any of the plurality of tag images displayed on the display.

8. An information processing method for causing a processor to execute:
detecting a position on a display, the position being designated,
generating a plurality of tag images each by associating the position with input information that is input,
determining based on a category of the input information, a priority order for displaying the plurality of tag images, and
displaying the plurality of tag images on the display based on the priority order.

9. A non-transitory computer-readable recording medium storing an information processing program for causing a processor to execute:
detecting a position on a display, the position being designated,
generating a plurality of tag images each by associating the position with input information that is input,
determining based on a category of the input information, a priority order for displaying the plurality of tag images, and
displaying the plurality of tag images on the display based on the priority order.
